(19) United States
(12) Patent Application Publication
(10) Pub. No.: US 2010/0043026 A1
(43) Pub. Date: Feb. 18, 2010

(54) METHOD AND DEVICE FOR BROADCASTING ADDITIONAL INFORMATION IN A SYSTEM FOR BROADCASTING VIDEO PROGRAMS

(75) Inventors: Philippe De Cuetos, Paris (FR); Gwénaël Durand, Paris (FR); Jérémie Leullier, Paris (FR); Cédric Thienot, Paris (FR)

Correspondence Address: SEED INTELLECTUAL PROPERTY LAW GROUP PLLC, 701 FIFTH AVE, SUITE 5400, SEATTLE, WA, 98104, US

(73) Assignee: EXPWAY, Reims (FR)

(21) Appl. No.: 12/568,523

(22) Filed: Sep. 28, 2009

Related U.S. Application Data
(63) Continuation-in-part of application No. PCT/IB2007/001890, filed on Jun. 26, 2007.
(60) Provisional application No. 60/908,487, filed on Mar. 28, 2007.

(51) Int. Cl. H04N 5/445

(52) U.S. Cl. 725/40

(57) ABSTRACT

There is provided a method of displaying additional content by a user terminal, comprising: receiving by the terminal digital content items of video broadcasting services, the digital content items comprising video programs, displaying by the terminal a content item selected from the received digital content items, receiving by the terminal additional content items associated with one of the video broadcasting services and with context data, and displaying by the terminal a content item selected from the received additional content items if a current context of the terminal corresponds to the context data of the content item.

### BACKGROUND

1. Technical Field

The present disclosure relates in general to the field of computer systems for transmitting structured data to fixed or mobile terminals. The present disclosure more particularly relates to video program guide broadcasting, for example according to standard ESG (Electronic Service Guide), in a video program broadcasting system of the type IP Datacast (IPDC). The broadcasting system IPDC is based on standard DVB-H (Digital Video Broadcast—Handheld) which is specified in ETSI 102 471 V1.1.1 (2006-04), “Digital Video Broadcasting (DVB); IP Datacast over DVB-H: Electronic Service Guide (ESG)”.

2. Description of the Related Art

The System IPDC provides ESG information, i.e. digital contents and video program services using mechanisms based on IP protocol (Internet Protocol). These mechanisms are optimized for terminals having low computation power and low power autonomy. The IPDC system comprises unidirectional broadcasting links transmitting ESG information structured in the form of data blocks the structure of which is compliant with IPDC. The ESG fragments are transported through the broadcasting links in sessions according to the FLUTE protocol (File Delivery over Unidirectional Transport).

The available ESG information is provided by the mobile network operators and the video program service providers. In this context, it is desirable to display additional broadcasted data on a terminal user such as advertisement messages which are adapted to a user profile (i.e. user preferences, mobile network operator of the user).

It is further desirable to display additional broadcasted data on a user terminal as a function of a current display context of the user terminal, i.e. an ESG page, service or program currently displayed by the user terminal.

It is further desirable to schedule display of additional broadcasted data for example in a specified time range independently or not from a video program.

### BRIEF SUMMARY

Thus, in one embodiment, a method is provided for displaying additional content by a user terminal, the method comprising:

receiving by the terminal digital content items of video broadcasting services, the digital content items comprising video programs,

displaying by the terminal a content item selected from the received digital content items,

receiving by the terminal additional content items associated with one of the video broadcasting services and with context data, and

displaying by the terminal a content item selected from the received additional content items if a current context of the terminal corresponds to the context data of the content item.

According to an embodiment, the context data of a received additional content item comprises a type of a current page displayed by the terminal, the additional content item to be displayed being selected by the terminal as a function of its associated current page type with respect to the type of the page currently displayed by the terminal.

According to an embodiment, the additional content items are linked to additional content broadcasting services, the additional broadcasting services being associated with types of pages displayed by the terminal, the type of the displayed additional content item being the type associated with an additional broadcasting service linked to the additional content item.

According to an embodiment, the context data of an additional content item comprises a genre of the additional content item, the additional content item to be displayed being selected by the terminal as a function of its genre with respect to subjects of interest of the terminal user memorized by the terminal.

According to an embodiment, the context data of an additional content item comprises a subject of a video program, the additional content item to be displayed being selected as a function of its video program subject with respect to a subject of a video program currently displayed by the terminal.

According to an embodiment, each additional content item is associated with a priority level, the additional content item to be displayed being selected as a function of its associated priority level with respect to priority levels associated to other additional content items received by the terminal.

According to an embodiment, at least one of the additional content items is associated with scheduling data, and displayed by the terminal only during a period specified by the scheduling data.

According to an embodiment, an additional content item received by the terminal comprises access data for the terminal to access to other content items, the method comprising retrieving other additional content items to be displayed, by means of the access data.

According to an embodiment, the access data comprise an URL address of a HTTP content accessible by the terminal through a mobile communication network.

According to an embodiment, the access data comprise an identifier of a content item broadcasted in a FLUTE session.

According to an embodiment, an additional content item is broadcasted in a structured content data block associated with an additional content broadcasting service.

According to an embodiment, the additional content broadcasting service is linked to at least one video broadcasting service.

An embodiment provides a terminal for receiving and displaying additional content, configured to:

receive digital content items of video broadcasting services, the digital content items comprising video programs,

display a content item selected from the received digital content items,

receive additional content items associated with one of the video broadcasting services and with context data, and

display a content item selected from the received additional content items if a current context of the terminal corresponds to the context data of the content item.

According to an embodiment, the context data of a received additional content item comprises a type of a current page displayed by the terminal, the additional content item to be displayed being selected as a function of a type of the additional content item with respect to the type of the page currently displayed by the terminal.

According to an embodiment, the additional content items are linked to additional content broadcasting services, the additional broadcasting services being associated with types of pages displayed by the terminal, the type of the displayed additional content item being the type associated with an additional broadcasting service linked to the additional content item.

According to an embodiment, the context data of an additional content item comprises a genre of the additional content item, the terminal being configured to select an additional content item to be displayed as a function of the genre of the additional content item with respect to subjects of interest of the terminal user memorized by the terminal.

According to an embodiment, the context data of an additional content item comprises a subject of a video program, the terminal being configured to select an additional content item to be displayed as a function of a subject of a video program currently displayed by the terminal.

According to an embodiment, each additional content item is associated with a priority level, the terminal being configured to select the additional content item to be displayed as a function of the priority levels associated to additional content items received by the terminal.

According to an embodiment, at least one of the additional content items is associated with scheduling data, the terminal being configured to display an additional content item associated with scheduling data only during a period specified by the scheduling data.

According to an embodiment, an additional content item received by the terminal comprises access data specifying a way for the terminal to access to other content items, the terminal being configured to retrieve other additional content items to be displayed, by means of the access data.

According to an embodiment, the access data comprise an URL address of a HTTP content, the terminal being configured to access to be HTTP content through a mobile communication network.

According to an embodiment, the access data comprise an identifier of a content item broadcasted in a FLUTE session.

According to an embodiment, an additional content item received by the terminal is broadcasted in a structured content data block associated with an additional content broadcasting service

According to an embodiment, the additional content broadcasting service is linked to at least one video broadcasting service.

According to an embodiment, the terminal is of the type mobile terminal having low power autonomy and comprising wireless reception means for receiving broadcasted content items.

An embodiment provides a video program broadcasting method comprising steps of:

broadcasting digital content items of video broadcasting services, the digital content items comprising video programs, and

broadcasting additional content items each being associated with one of the video broadcasting services and with context data specifying a current terminal context in which a terminal receiving the digital content items and the additional content items must be for displaying the additional content item.

According to an embodiment, the context data comprise a type of a current page displayed by a terminal.

According to an embodiment, the additional content items are linked to additional content broadcasting services, the additional broadcasting services being associated with types of pages displayed by the terminal.

According to an embodiment, the context data comprises a genre of the additional content item.

According to an embodiment, the context data comprises a subject of a video program.

According to an embodiment, at least one of the additional content items is associated with a priority level.

According to an embodiment, at least one of the additional content items is associated with scheduling data specifying a period during which the associated additional content item can be displayed by a terminal.

According to an embodiment, a broadcasted additional content item comprises access data for a terminal to access to other content items.

According to an embodiment, the access data comprise an URL address of a HTTP content accessible by a terminal through a mobile communication network.

According to an embodiment, the access data comprise an identifier of a content item broadcasted in a FLUTE session.

According to an embodiment, an additional content item is broadcasted in a structured content data block associated with an additional content broadcasting service

According to an embodiment, the additional content broadcasting service is linked to at least one video broadcasting service.

An embodiment provides a broadcasted video program server configured to:

provide digital content items to be broadcasted of video broadcasting services, the digital content items comprising video programs, and provide additional content items to be broadcasted each being associated with one of the video broadcasting services and with context data specifying a current terminal context in which a terminal receiving the digital content items and the additional content items must be for displaying the additional content item.

According to an embodiment, the context data comprise a type of a current page displayed by a terminal.

According to an embodiment, the additional content items to be broadcasted are linked to additional content broadcasting services, the additional broadcasting services being associated with types of pages displayed by the terminal.

According to an embodiment, the context data of an additional content item to be broadcasted comprises a genre of the additional content item.

According to an embodiment, the context data of an additional content item to be broadcasted comprises a subject of a video program.

According to an embodiment, at least one of the additional content items to be broadcasted is associated with a priority level.

According to an embodiment, at least one of the additional content items to be broadcasted is associated with scheduling data specifying a period during which the associated additional content item can be displayed by a terminal.

According to an embodiment, an additional content item to be broadcasted comprises access data for a terminal to access to other content items.

According to an embodiment, the access data comprise an URL address of a HTTP content accessible by a terminal through a mobile communication network.

According to an embodiment, the access data comprise an identifier of a content item broadcasted in a FLUTE session.

According to an embodiment, an additional content item to be broadcasted is inserted into a structured content data block associated with an additional content broadcasting service.

According to an embodiment, the additional content broadcasting service is linked with at least one video broadcasting service.

### BRIEF DESCRIPTION OF THE SEVERAL VIEWS OF THE DRAWINGS

These and other features and advantages of the present disclosure will be presented in greater detail in the following description of an embodiment of the invention in relation with, but not limited to the appended drawings in which:

FIG. 1 represents in block form a broadcasting system of video program guides in a video program broadcasting system,

FIG. 2 represents in block form a software architecture of a mobile terminal for receiving and displaying video programs and program guides,

FIG. 3 represents in block form the structure of ESG information,

FIG. 4 represents in block form the structure of ESG information linked to the structure of additional data according to an embodiment,

FIG. 5 is a representation of a video broadcasting service and an additional content broadcasting service linked to the video broadcasting service, according to an embodiment,

FIG. 6 represents screen pages displayed by an ESG application of a user terminal,

FIG. 7 is a flow chart of a sequence executed by the ESG application,

FIG. 8 represents the structure of data blocks broadcasted to the user terminals.

### DETAILED DESCRIPTION

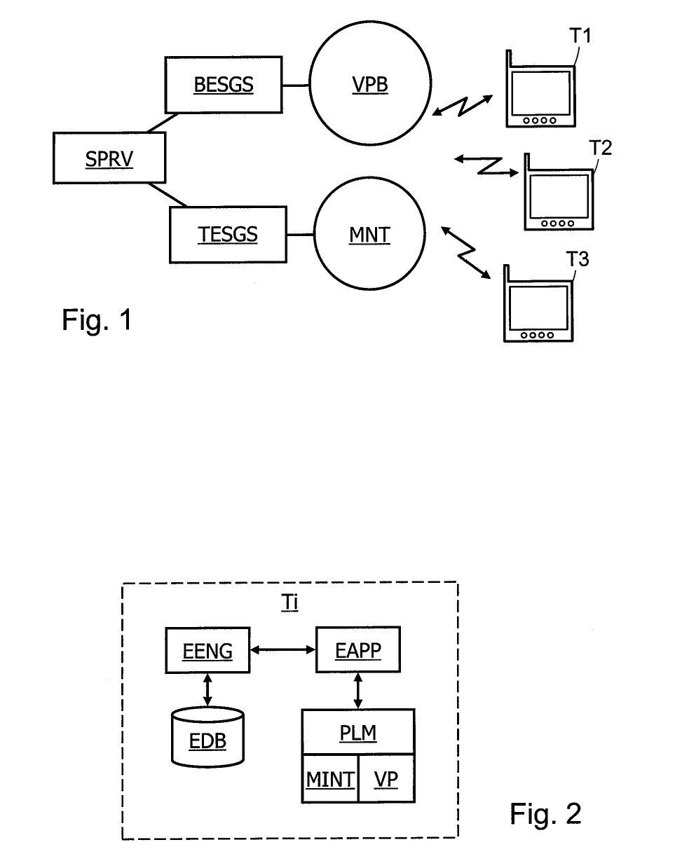

FIG. 1 represents a video program broadcasting system VPB broadcasting programs and program guide data related to the video programs, and mobile user terminals T1, T2, T3 adapted to receive video programs and program guide data broadcasted by the system VPB.

Program guide data are generated by a program guide server BESGS, information contained in the program guides being provided to BESGS server by a program server SPRV. Video programs and program guide data are broadcasted by the system VPB for example according to the standard DVB-H.

The terminals T1-T3 can comprise transmission means for communicating with a mobile phone network MNT which can be used to provide additional data related or not to the broadcasted video programs. These additional data can be transmitted by server SPRV either to server BESGS or to another program guide server TESGS connected to the mobile network MNT.

FIG. 2 represents the architecture of a terminal T. Each terminal T1-T3 comprises an ESG engine module EENG, an ESG application module EAPP, and a player module PLM. The module EENG receives the program guide data and stores them in a database EDB. The module EAPP receives from the user of the terminal selection commands of video program or program guide data and processes the selection commands to retrieve corresponding program guide data or video programs. The retrieved information is then provided to the module PLM. Module PLM uses adapted player modules MINT, VP to display the information retrieved in the database EDB and selected by the user. Module MINT is a browser for displaying multimedia information provided by an Internet interface. Module VP is a video player compatible with at least one video standard such as H.264 (MPEG-4 AVC).

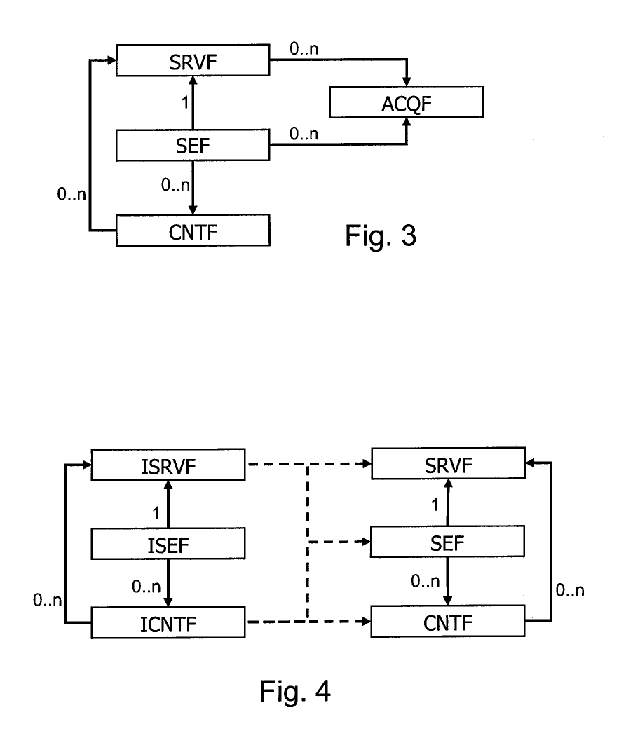

The program guide data are transmitted in sessions for example according to the FLUTE protocol (File deLivery over Unidirectional Transport) or DVB-STP (DVB-Service Discovery and Selection Transport Protocol). The video program guide data comprise structured data blocks called “fragments”. FIG. 3 represents the ESG fragments and relations between the latter. As shown in FIG. 3, the program guide data comprises ESG service fragments SRVF, ESG content fragments CNTF, ESG schedule event fragments SEF, and ESG acquisition fragments ACQF. A fragment SRVF can be linked to one or more content fragments CNTF, one or more acquisition fragments ACQF, and one or more schedule event fragment SEF. A fragment SEF can be linked to one or more fragments ACQF.

A fragment SRVF comprises information describing an IPDC service such as a traditional TV channel or a service supplying ring tones for mobile phones. A fragment SRVF comprises information such as a service name, a service identifier, a service logo, a textual description of the service, a genre and type of the service, information related to the service provider, and an identifier of an acquisition fragment ACQF.

A content fragment CNTF comprises information or metadata describing a content item such as a video program independently of the content data format. A fragment CNTF comprises a content identifier, a title, a textual summary, a genre and type of the content item, an identifier of a service fragment SRVF to which the content is linked, and a duration of the content, i.e. the time required by a terminal to display (or play) the content item.

A schedule event fragment SEF specifies a period during which a scheduled content item of a service is broadcasted. A fragment SEF comprises an identifier of the fragment, a start and end times the associated content item is displayed, a service identifier and a content item identifier to which the fragment SEF is assigned. A fragment SEF can further comprise an acquisition fragment ACQF identifier identifying a fragment ACQF to which the fragment SEF is linked.

In an example, the structure of the fragments SRVF, CNTF, SEF is specified in XML language. The structure of a fragment SRVF comprises at least the following fields:

ServiceGenre which specifies a genre or subject characterizing the media content available from the corresponding service,

ServiceType which specifies the type of the corresponding service, e.g. a download service, a streaming service or a combination of the latter,

ServiceProvider which specifies the provider offering the corresponding service,

AcquisitionRef which specifies the identifier of a acquisition fragment ACQF providing generic information necessary to access to the corresponding service,

RelatedMaterial which specifies a reference to information related to the service, e.g. an address (URL) of a web site providing more information about content provided by the corresponding service,

ServiceId which is a unique identifier of the corresponding service,

In the above example, the structure of a content fragment CNTF comprises in particular the following fields:

ServiceRef which specifies the service identifier of the service fragment SRVF to which the corresponding content is associated,

Genre which specifies a genre or subject that characterizes the corresponding content,

ContentType which is optional and specifies a type of the corresponding content, e.g. a downloaded or streaming content,

RelatedMaterial which specifies a reference to information related to the corresponding content, such as an address (URL) of a web site providing more information about the corresponding content,

Duration which specifies the duration for displaying or playing the corresponding content,

ContentId which specifies a unique identifier for the content fragment

The structure of a fragment SEF comprises in particular the following fields:

PublishedStartTime which specifies a start time of the corresponding scheduled item,

PublishedEndTime which specifies an end time of the corresponding scheduled item,

ServiceRef which specifies the service fragment identifier of the service fragment the corresponding schedule event is assigned to,

ContentRef which specifies the content fragment identifier of the content available during the corresponding schedule event,

AcquisitionRef which specifies the acquisition fragment identifier of the acquisition fragment that describes the format and acquisition parameters for the content fragment referenced by the previous field ContentRef,

ContentLocation which specifies the URI (Uniform Resource Identifier) of the content location of the content fragment referenced by the previous field ContentRef within the FLUTE session described in the acquisition fragment referenced by the field AcquisitionRef,

ScheduleID which specifies a unique identifier for the corresponding schedule event fragment.

According to an embodiment, additional services are linked to ESG services and are specified with additional service fragments, schedule event fragments and content fragments. As depicted in FIG. 4, additional services are specified using an additional service fragment ISRVF for each additional service, additional content fragments ICNTF and additional schedule event fragments ISEF. The additional fragments ISRVF, ICNTF and ISEF have a data structure similar to that of the corresponding ESG fragments SRVF, CNTF and SEF. In addition, each fragment ISRVF and ICNTF can be linked to one or more ESG fragments SRVF, CNT and SEF. Each of these links is specified using an instance of the field RelatedMaterial of the additional service or content fragment. The field RelatedMaterial comprises two elements namely HowRelated and MediaLocator. The MediaLocator element has a MediaURI element specifying an ESG service, content or schedule event fragment identifier. The HowRelated element has a HREF attribute specifying a link type which may be set to “related service fragment”, “related content fragment” or “related schedule event fragment”, indicating the type of the associated content specified by the MediaURI element. An additional service fragment ISRVF is distinguished from an ESG service fragment SRVF using the ServiceType field which is set to a special value, for example “advertising” for an advertising additional service.

Content of an additional content fragment ICNTF is described by a set of RelatedMaterial fields. A RelatedMaterial field can be used to define access data to access to content media or text to be displayed. The access data can comprise a URI (Uniform Resource Identifier) referring to data received in FLUTE sessions and stored in the database EDB, or to data available at a HTTP (HyperText Transfer Protocol) site accessible for example through a data link of a mobile network to which the user terminal is connected. A RelatedMaterial field can comprise a MediaLocator attribute specifying a link URI such as a HTTP URL (Uniform Resource Locator).

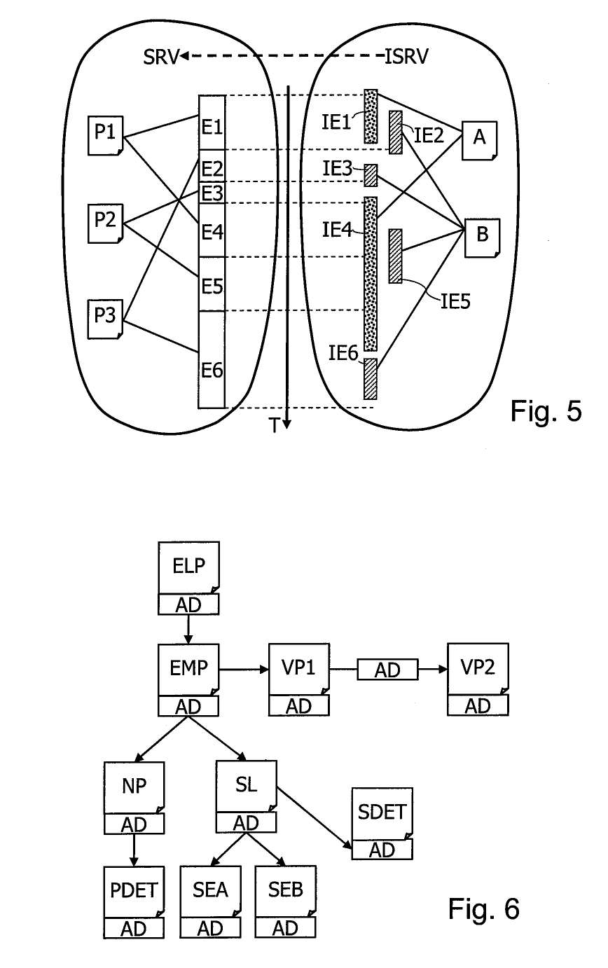

FIG. 5 is a representation of an ESG service SRV and an additional service ISRV linked to the ESG service. The service SRV comprises ESG content fragments P1, P2, P3 corresponding for example to video programs, and schedule event fragments E1-E6. The content fragment P1 is scheduled using the schedule event fragments E1 and E4. This means that the video program P1 is broadcasted during display periods defined by the start and end times fields of the schedule event fragments E1 and E4. In a similar manner, the content fragment P2 is scheduled using the schedule event fragments E3 and E5, and the content fragment P3 is scheduled using the schedule event fragments E2 and E6.

The additional service fragment ISRVF comprises additional content fragments A and B, and additional schedule event fragments IE1-IE6. The content fragment A is scheduled using the additional schedule event fragments IE1 and IE4. The content fragment B is scheduled using the additional schedule event fragments IE2, IE3, IE5 and IE6.

The display periods of the schedule events fragments E1-E6 and IE1-IE6 are represented in FIG. 5 along a temporal axis T. Note that as shown in FIG. 5 the display periods of additional schedule event fragments of a same additional service can overlap. In the case of an additional service of advertising, content items to be displayed of content fragments linked to the additional service are generally still pictures or text. These additional content items are displayed in a currently displayed image of an ESG service content. When additional content fragments are scheduled at the same time, they are not displayed at the same time by the terminal T1-T3 but one content fragment to be displayed is selected as a function of a current context of the terminal.

FIG. 6 represents an example of screen pages displayed by the ESG application EAPP. When activating and loading the ESG application, a loading page ELP is displayed on the screen of the terminal T1-T3. Once the ESG application is loaded in the memory of the terminal and activated, an ESG main page EMP is displayed. From the page EMP, the user can activate an ESG service VP1, i.e. a video program channel. The user can activate another ESG service VP2 from the service VP1 (zapping between services). From the page EMP the user can also trigger display of a page NP showing a list of currently broadcasted video programs by available ESG services, or a page SL showing a list of the available or accessible ESG services. The page NP gives access to a page PDET showing detailed information about a program selected in the page NP. The page SL gives access to program guides SEA, SEB of the available services, and to a page SDET displaying detailed information about a service selected in the page SL.

According to an embodiment, an additional service ISRV is linked to one or more of the ESG screen pages by means of one or more ServiceGenre fields in the additional service fragment ISRVF of the additional service set to the identifier of an ESG page. In the example of FIG. 6, page identifiers (termID=1 to 9) can be defined in XML language as follows:

```
  <ClassificationScheme uri=“...cs:interactivity:ContextCS”>
  <Term termID=“1”>
    <Name xml:lang=“en”>Mobile TV application Launch</Name>
    <Definition xml:lang=“en”>
    </Definition>
  </Term>
  <Term termID=“2”>
    <Name xml:lang=“en”>ESG Home/Main page</Name>
  </Term>
  <Term termID=“3”>
    <Name xml:lang=“en”>“Now playing” page</Name>
  </Term>
  <Term termID=“4”>
    <Name xml:lang=“en”>Service List page</Name>
  </Term>
  <Term termID=“5”>
    <Name xml:lang=“en”>Program detail page</Name>
  </Term>
  <Term termID=“6”>
    <Name xml:lang=“en”>Program Guide Page for a
service</Name>
  </Term>
  <Term termID=“7”>
    <Name xml:lang=“en”>Service detail page</Name>
  </Term>
  <Term termID=“8”>
    <Name xml:lang=“en”>Zapping between services </name>
  </Term>
  <Term termID=“9”>
    <Name xml:lang=“en”>Watching services/content</Name>
  </Term>
```

A field ServiceGenre (or Genre for a fragment ICNTF) can also be used to associate a priority level to an additional service fragment ISRVF or an additional content fragment ICNTF.

If an additional content is scheduled, it is displayed by a user terminal at times scheduled by an associated schedule event fragment ISEF if the terminal is in a context (e.g. screen page type of the currently displayed page) corresponding to a data (e.g. a ServiceGenre field value) of the corresponding additional service fragment ISRVF. If the additional content is not associated with a fragment ISEF, the additional content is always displayed when the terminal is in the associated context.

The additional content displayed can be a banner with text and/or one or more images covering a part of the terminal display screen. It can also cover completely the terminal display screen, for example during the time necessary for the terminal to load a newly selected video program.

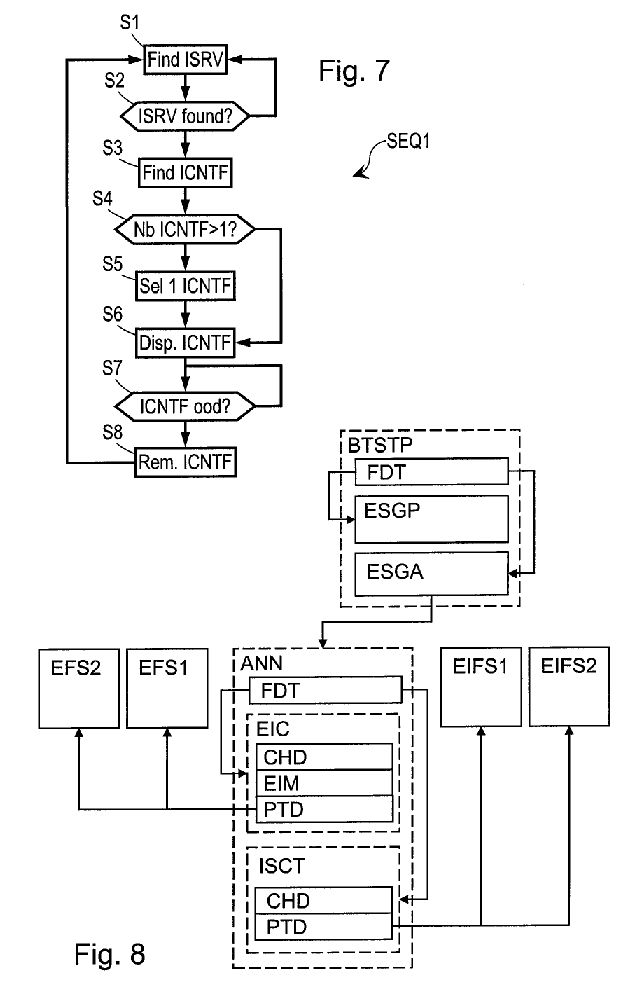

The ESG application EAPP activated on a user terminal T1-T3 executes a sequence SEQ1 as shown in FIG. 7 when a current context of the terminal T1-T3 is changed, e.g. when a new screen page of the pages shown in FIG. 6 is displayed. Sequence SEQ1 comprises steps S1 to S8. At step S1, the terminal looks for additional service fragments ISRVF defined for the current context of the terminal. A selection of additional service fragments can be performed as a function of contexts of the found additional services (defined by fields ServiceGenre of the found additional services) with respect to the terminal context (currently displayed page). If an additional service fragment ISRVF is found at next step S2, the terminal looks for additional content fragments ICNTF and additional schedule event fragments ISEF, linked to the found fragment ISRVF (step S3). These search operations are performed by the application EAPP by sending a request to the ESG engine EENG. From the found additional content and schedule event fragments, the terminal then identifies the content fragments ICNTF which are not scheduled (not linked to a fragment ISEF) and the content fragments scheduled at the current time (linked to a fragment ISEF indicating that the associated content fragment is to be currently displayed). If more than one not scheduled or currently scheduled fragment ICNTF is found at step S4, a fragment ICNTF is selected from the found additional content fragments (step S5). The selection of an additional content fragment to be displayed can be performed as a function of subjects of the found additional content fragments (defined by the field Genre of the additional content fragment) with respect to the Genre of the currently displayed ESG content fragment and/or user personalization data stored by the user terminal, e.g. subjects of interest specified by the terminal user. The selection of an additional content fragment to be displayed can further be performed as a function of a priority level attributed to the additional content fragments. If several additional content fragments are associated with the same context and same priority level, one additional content fragment to be displayed is randomly selected. Alternatively a pop-up window showing the available additional content fragments can be displayed so as to enable the user to select one of the available content fragments.

At the next step S6, the additional content fragment ICNTF selected at step S5 or the unique fragment ICNTF found at step S3 is displayed. If the additional content fragment contains several content items, the content items may be displayed sequentially. If one of the additional content items is of the type link URI defined in the MediaLocator attribute of the RelatedMaterial field, the terminal checks first if a module e.g. module MINT or module VP, can process the link. If the link can not be processed by the terminal, the additional content is not displayed without any notification of the user.

At next step S7, if the displayed content is associated with a fragment ISEF, the terminal removes the displayed content from the display screen when it becomes out-of-date according to the associated fragment ISEF at step S8. After step S8, the terminal executes step S1 again for looking for other content fragments to be displayed.

According to a use example of the above described embodiment, an additional service of the type advertising can be defined and configured for each mobile network operators, and for each video channel providers, and possibly for each video program providers. The advertising services of the mobile network operators are linked through a ServiceGenre field to screen pages ELP, EMP, SL and NP. Thus when a user terminal displays one of these pages, it also displays a banner AD containing content items of an additional content fragment linked to the advertising service of the mobile network operator of the terminal. In a similar manner, the advertising services of the video channel providers are linked to screen pages SDET, SEA, SEB, and possibly to several screen pages PDET. When a user terminal displays one of these pages or accesses to video program VP1, VP2, it also displays a page or a banner AD containing content items of an additional content fragment linked to an advertising service of the video channel provider which provides the video channel selected by the terminal. If the terminal selects a video program (display of pages PDET, VP1, VP2) provided by a video program provider distinct from a video channel provider, the terminal can also display content items of an additional content fragment linked to the advertising service of the video program provider which provides the video program selected by the terminal.

FIG. 8 represents the structure of the data blocks which are broadcasted to the user terminals T1-T3 according to FLUTE protocol by the server BESGS. The broadcasted data comprises a start data stream BTSTP, called “bootstrap session”, acquisition data streams ANN called “announcement sessions”, and program guide data streams EFS1, EFS2 called “ESG sessions”.

The bootstrap session BTSTP comprises data which are necessary to start a program guide service, i.e. data indicating the available program guides and how to get an announcement session ANN corresponding to a particular program guide. Each announcement session ANN contains data indicating how to get the ESG sessions EFS1, EFS2 of the program guide corresponding to the session ANN. The program guide data of the ESG sessions EFS1, EFS2 comprises data also called “meta-data” to be displayed by a user terminal and data to access to video programs.

Each data stream is broadcasted and accessible at a particular IP address. The IP address of the bootstrap session BTSTP is known from the user terminals. Each data stream or session comprises several data blocks, each having an identifier, and a table FDT (File Delivery Table) giving the structure of the session, i.e. the location in the session and the structure of each data block of the session. In the example of FIG. 8, the session BTSTP comprises two data blocks ESGP, ESGA. The block ESGP comprises information about program guide providers. The block ESGA comprises access data and in particular the IP address of the announcement session of each program guide provider listed in the block ESGP.

Each announcement session ANN comprises data for accessing to a program guide of an operator and for a given user terminal type. Each session ANN comprises data describing how the program guide data to be displayed are dispatched into ESG sessions EFS1, EFS2 and access data (IP addresses) to these sessions. Each session ANN comprises a table FDT and a data block EIC. The table FDT describes the structure of the data blocks of the session and the position in the session of each data block. The block EIC comprises a header CHD, an initialization message EIM, and a partition declaration PTD defining the transmission format of the corresponding program guide data, and in particular the number and IP addresses of the ESG sessions EFS1, EFS2. Like the sessions BTSTP, ANN, each session EFS1, EFS2 comprises a table FDT and data blocks corresponding to the fragments SRVF, CNTF, SEF described above.

Each session BTSTP, ANN, EFS1, EFS2 is broadcasted according to a FLUTE carousel during repeated broadcasting cycles. Thus the whole data of a session can be acquired by accessing to the IP address of the session and by listening the data stream during a broadcasting cycle.

According to an embodiment, the fragments ISRVF, ICNTF, ISEF are broadcasted in additional sessions EIFS1, EIFS2 referenced in a data block ISCT of the announcement session ANN. Like the data block EIC, the data block ISCT comprises a header CHD and a partition declaration PTD defining the transmission format of the corresponding additional service data, and in particular the number and IP addresses of the additional sessions EIFS1, EIFS2.

It will be understood by those skilled in the art that various other applications and alternative embodiments of the method according to the present disclosure are possible. Thus the present disclosure is not limited to the standards ESG and IP Datacast over DVB-H. An embodiment of the present disclosure can be applied to any other digital data broadcasting standard.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of displaying additional content by a user terminal, comprising:
receiving by the terminal digital content items of video broadcasting services, the digital content items comprising video programs,
displaying by the terminal a content item selected from the received digital content items,
receiving by the terminal additional content items associated with one of the video broadcasting services and with context data, and
displaying by the terminal a content item selected from the received additional content items if a current context of the terminal corresponds to the context data of the content item.

2. The method according to claim 1, wherein the context data of a received additional content item comprises a type of a current page displayed by the terminal, the additional content item to be displayed being selected by the terminal as a function of its associated current page type with respect to the type of the page currently displayed by the terminal.

3. The method according to claim 2, wherein the additional content items are linked to additional content broadcasting services, the additional broadcasting services being associated with types of pages displayed by the terminal, the type of the displayed additional content item being the type associated with an additional broadcasting service linked to the additional content item.

4. The method according to claim 1, wherein the context data of an additional content item comprises a genre of the additional content item, the additional content item to be displayed being selected by the terminal as a function of its genre with respect to subjects of interest of the terminal user memorized by the terminal.

5. The method according to claim 1, wherein the context data of an additional content item comprises a subject of a video program, the additional content item to be displayed being selected as a function of its video program subject with respect to a subject of a video program currently displayed by the terminal.

6. The method according to claim 1, wherein each additional content item is associated with a priority level, the additional content item to be displayed being selected as a function of its associated priority level with respect to priority levels associated to other additional content items received by the terminal.

7. The method according to claim 1, wherein at least one of the additional content items is associated with scheduling data, and displayed by the terminal only during a period specified by the scheduling data.

8. The method according to claim 1, wherein an additional content item received by the terminal comprises access data for the terminal to access to other content items, the method comprising retrieving other additional content items to be displayed, by means of the access data.

9. The method according to claim 8, wherein the access data comprise an URL address of a HTTP content accessible by the terminal through a mobile communication network.

10. The method according to claim 8, wherein the access data comprise an identifier of a content item broadcasted in a FLUTE session.

11. The method according to claim 1, wherein an additional content item is broadcasted in a structured content data block associated with an additional content broadcasting service.

12. The method according to claim 1, wherein the additional content broadcasting service is linked to at least one video broadcasting service.

13. A terminal for receiving and displaying additional content, configured to:
receive digital content items of video broadcasting services, the digital content items comprising video programs,
display a content item selected from the received digital content items, receive additional content items associated with one of the video broadcasting services and with context data, and
display a content item selected from the received additional content items if a current context of the terminal corresponds to the context data of the content item.

14. The terminal according to claim 13, wherein the context data of a received additional content item comprises a type of a current page displayed by the terminal, the additional content item to be displayed being selected as a function of a type of the additional content item with respect to the type of the page currently displayed by the terminal.

15. The terminal according to claim 13, wherein the additional content items are linked to additional content broadcasting services, the additional broadcasting services being associated with types of pages displayed by the terminal, the type of the displayed additional content item being the type associated with an additional broadcasting service linked to the additional content item.

16. The terminal according to claim 13, wherein the context data of an additional content item comprises a genre of the additional content item, the terminal being configured to select an additional content item to be displayed as a function of the genre of the additional content item with respect to subjects of interest of the terminal user memorized by the terminal.

17. The terminal according to claim 13, wherein the context data of an additional content item comprises a subject of a video program, the terminal being configured to select an additional content item to be displayed as a function of a subject of a video program currently displayed by the terminal.

18. The terminal according to claim 13, wherein each additional content item is associated with a priority level, the terminal being configured to select the additional content item to be displayed as a function of the priority levels associated to additional content items received by the terminal.

19. The terminal according to claim 13, wherein at least one of the additional content items is associated with scheduling data, the terminal being configured to display an additional content item associated with scheduling data only during a period specified by the scheduling data.

20. The terminal according to claim 13, wherein an additional content item received by the terminal comprises access data specifying a way for the terminal to access to other content items, the terminal being configured to retrieve other additional content items to be displayed, by means of the access data.

21. The terminal according to claim 20, wherein the access data comprise an URL address of a HTTP content, the terminal being configured to access to be HTTP content through a mobile communication network.

22. The terminal according to claim 20, wherein the access data comprise an identifier of a content item broadcasted in a FLUTE session.

23. The terminal according to claim 13, wherein an additional content item received by the terminal is broadcasted in a structured content data block associated with an additional content broadcasting service

24. The terminal according to claim 13, wherein the additional content broadcasting service is linked to at least one video broadcasting service.

25. The terminal according to claim 13, of the type mobile terminal having low power autonomy and comprising wireless reception means for receiving broadcasted content items.

26. A video program broadcasting method comprising:
broadcasting digital content items of video broadcasting services, the digital content items comprising video programs, and
broadcasting additional content items each being associated with one of the video broadcasting services and with context data specifying a current terminal context in which a terminal receiving the digital content items and the additional content items must be for displaying the additional content item.

27. The method according to claim 26, wherein the context data comprise a type of a current page displayed by a terminal.

28. The method according to claim 27, wherein the additional content items are linked to additional content broadcasting services, the additional broadcasting services being associated with types of pages displayed by the terminal.

29. The method according to claim 26, wherein the context data comprises a genre of the additional content item.

30. The method according to claim 26, wherein the context data comprises a subject of a video program.

31. The method according to claim 26, wherein at least one of the additional content items is associated with a priority level.

32. The method according to claim 26, wherein at least one of the additional content items is associated with scheduling data specifying a period during which the associated additional content item can be displayed by a terminal.

33. The method according to claim 26, wherein a broadcasted additional content item comprises access data for a terminal to access to other content items.

34. The method according to claim 33, wherein the access data comprise an URL address of a HTTP content accessible by a terminal through a mobile communication network.

35. The method according to claim 33, wherein the access data comprise an identifier of a content item broadcasted in a FLUTE session.

36. The method according to claim 26, wherein an additional content item is broadcasted in a structured content data block associated with an additional content broadcasting service

37. The method according to claim 26, wherein the additional content broadcasting service is linked to at least one video broadcasting service.

38. A broadcasted video program server, comprising:
means for providing digital content items to be broadcasted of video broadcasting services, the digital content items comprising video programs, and
means for providing additional content items to be broadcasted each being associated with one of the video broadcasting services and with context data specifying a current terminal context in which a terminal receiving the digital content items and the additional content items must be for displaying the additional content item.

39. The server according to claim 38, wherein the context data comprise a type of a current page displayed by a terminal.

40. The server according to claim 39, wherein the additional content items to be broadcasted are linked to additional content broadcasting services, the additional broadcasting services being associated with types of pages displayed by the terminal.

41. The server according to claim 38, wherein the context data of an additional content item to be broadcasted comprises a genre of the additional content item.

42. The server according to claim 38, wherein the context data of an additional content item to be broadcasted comprises a subject of a video program.

43. The server according to claim 38, wherein at least one of the additional content items to be broadcasted is associated with a priority level.

44. The server according to claim 38, wherein at least one of the additional content items to be broadcasted is associated with scheduling data specifying a period during which the associated additional content item can be displayed by a terminal.

45. The server according to claim 38, wherein an additional content item to be broadcasted comprises access data for a terminal to access to other content items.

46. The server according to claim 45, wherein the access data comprise an URL address of a HTTP content accessible by a terminal through a mobile communication network.

47. The server according to claim 45, wherein the access data comprise an identifier of a content item broadcasted in a FLUTE session.

48. The server according to claim 38, wherein an additional content item to be broadcasted is inserted into a structured content data block associated with an additional content broadcasting service.

49. The server according to claim 38, wherein the additional content broadcasting service is linked with at least one video broadcasting service.
